(19) United States
(12) Patent Application Publication
(10) Pub. No.: US 2010/0266480 A1
(43) Pub. Date: Oct. 21, 2010

(54) Method for Preparing a Trace Element Additive Basic Zinc Chloride

(76) Inventor: Yiqiang Huang, Hunan (CN)

Correspondence Address: Nields, Lemack & Frame, LLC, 176 E. Main Street, Suite #5, Westborough, MA, 01581, US

(21) Appl. No.: 12/224,054

(22) PCT Filed: Jul. 17, 2006
(86) PCT No.: PCT/CN2006/001710

§ 371 Date: Aug. 14, 2008

(30) Foreign Application Priority Data
May 25, 2006 (CN) 200610031714.4

(51) Int. Cl. C01B 9/02

(52) U.S. Cl. 423/491

(57) ABSTRACT

A method for preparing basic zinc chloride, a trace element additive, comprises 1) reacting zinc oxide with hydrochloric acid, wherein the mole ratio of zinc oxide to hydrochloric acid is 5:2, a certain amount of hydrochloric acid is previously diluted in 5-10 fold reaction water, then zinc oxide is added thereto, basic zinc chloride is produced by reacting for 1-3 hours under normal pressure condition at a temperature of 55-95 and pH of 6-8, a reaction liquid after centrifugal separation can be used as mother liquor to be recycled in next reaction, the reaction is as follows:

2HCl+5ZnO+4H₂O=Zn₅Cl₂(OH)₈·H₂O;

2) water washing, centrifugal separating; 3) oven drying, pulverizing, and packing.

This invention involves one preparation method of Basic Zinc Chloride in trace elements additive.

### TECHNICAL BACKGROUND

Basic Zinc Chloride is the alternative use of zinc sulfate and zinc chloride in animal feed additives, in today's Basic Zinc Chloride production, some utilized deposed zinc, some utilized Zinc chloride and Zinc oxide to reflect production. Some also utilized electroplating or line version of the etching solution to produce zinc. The shortcomings of these methods is that products containing too many impurities, it is difficult to deal with high content of heavy metals, emission in the reaction solution containing heavy metals and other pollutants on the environment pollution. Hence it is difficult to achieve higher standards of hygiene requirements and environmental requirements

### INVENTION CONTENTS

The technical problem in this invention is: Offering a high yield, with virtually no emission, less environmental pollution, low cost, simple techniques, high quality products, no impurities, higher hygiene standards Basic Zinc Chloride Preparation method.

Appeal to solve above technical problems, a method for preparing basic zinc chloride, a trace element additive, comprises:

1) Reacting zinc oxide with hydrochloric acid, wherein the mole ratio of zinc oxide to hydrochloric acid is 5:2, a certain amount of hydrochloric acid is previously diluted in 5-10 fold reaction water, then zinc oxide is added thereto, basic zinc chloride is produced by reacting for 1-3 hours under normal pressure condition at a temperature of 55-95 and PH of 6-8, a reaction liquid after centrifugal separation can be used as mother liquor to be recycled in next reaction, the reaction is as follows:

2HCl+5ZnO+4H₂O=Zn₅Cl₂(OH)₈·H₂O

2) Water washing, centrifugal separating;
3) Oven drying, pulverizing and packing.

This method can increase the purity of basic zinc chloride, because of the method use in hydrochloric acid and zinc oxide silence in the reaction of the water directly under the circumstances and in response, do not need to join the other promoting agent, and sediments in the last generation of Basic Zinc Chloride is not soluble in water, after dewatering no other by-products raised in reaction, centrifugal separation of the reaction can be used as liquor in the next reaction in recycling, and therefore almost no emission on the environment clean. The present invention also have advantages of simple technics, high efficiency, good quality products, no impurities, higher feed hygiene standards. As long as the use of food or medical grade materials will be able to produce a higher level of Basic Zinc Chloride.

### SPECIFIC IMPLEMENTATION PLAN

### Implementation 1

Firstly use 2 mol hydrochloric acid dilute in 5 times reaction water, then input 5 mol zinc oxide. At temperature 55° C. in response to regulation PH value of 6.5, the reaction of 1 hour, Water washing, centrifugal separating, drying, pulverizing, can be finished in the basic zinc chloride. Therein to zinc content is 57.5%. The reaction liquid after centrifugal separation can be used as mother liquor to be recycled in next reaction.

### Implementation 2

Use 200 mol hydrochloric acid dilute in 8 times reaction water. Then slowly input 500 mol zinc oxide. In the 75 degree temperature regulation under PH value of 7, react for 2 hours, Water washing, centrifugal separating, drying, pulverizing, can be finished in the basic zinc chloride Of zinc content of 60.5%. The reaction liquid after centrifugal separation can be used as mother liquor to be recycled in next reaction.

### Implementation 3

Use 20 mol hydrochloric acid dilute in 10 times reaction water. Then slowly put 50 mol zinc oxide. In the 95° C. degrees temperature regulation under PH value of 7.5, react for 3 hours, Water washing, centrifugal separating, drying, pulverizing, can be finished in the basic zinc chloride of 60% zinc content. The reaction liquid after centrifugal separation can be used as mother liquor to be recycled in next reaction.

Supplement standard dosage of the additive in pigs as zinc source, can promote growth, improve feed/meat ratio and the color of meat, increase resistance to disease, and that pig skin rosy, also can improve piglet's anti-stress capabilities and immunity, promoting growth and preventing piglet from diarrhea, extending the reproduction life of sow; Supplement standard dosage as zinc source feeding meat poultry, can increase the growth rate, feed/meat ratio decline, enhance feathers luster, raise their anti-stress capability and reduce mortality; by feeding standard dosage as zinc Source in aquatic animals can enhance immunity, lower morbidity and mortality, promoting production, reduce disease and the loss of feed utilization.

1. A method for the preparation of the trace element additive, basic zinc chloride, comprising:
setting the molar ratio of zinc oxide and hydrochloric acid at 5:2,
diluting a specified quantity of hydrochloric acid in 5 to 10 times its volume of reaction water,
reacting zinc oxide with said hydrochloric acid for 1 to 3 hours at a temperature of 55 to 95° C., a pH level controlled at 6 to 8 and at normal pressure, the reaction being as follows:
2HCl+5ZnO+4H₂O=Zn₅Cl₂(OH)₈·H₂O;
washing the reaction product with water and centrifuging for separation of said basic zinc oxide;
oven drying and pulverizing the separated basic zinc oxide.

2. The method of claim 1, further comprising recycling the mother liquor produced in said centrifuging step.
